(19) United States
(12) Patent Application Publication
(10) Pub. No.: US 2008/0082606 A1
(43) Pub. Date: Apr. 3, 2008

(54) SENDING AUTOMATIC REMINDERS TO INVITEES FOR INVITATIONS NOT ACTED ON

(75) Inventors: Pawan K. Gupta, Holden, MA (US); Samir J. Patel, Billerica, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/537,030

(22) Filed: Sep. 29, 2006

(51) Int. Cl. G06F 15/16

(52) U.S. Cl. 709/204

(57) ABSTRACT

A computer program product is provided for receiving invitations and automatically generating reminders for invitations that have not been one of accepted and declined. The program may be supplied as an add-in. The program provides for searching each invitation for a date, a start time, and a time duration; providing reminder generators for each invitation; removing reminder generators for the invitations that are one of accepted and declined by the recipient; displaying each invitation; receiving recipient input to one of accept and decline for each invitation; providing a conflict check between at least two invitations; providing a conflict alert notification to the recipient when at least two invitations conflict; resolving conflicts between at least two invitations; sending an accept message to a sender of an invitation accepted by the recipient; and sending a decline message to a sender of an invitation declined by the recipient.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to sending electronically generated reminders to recipients of invitations.

2. Description of the Related Art

Many people today receive electronic invitations to events via a computer. For example, these events can be meetings and classes. Typically, the computer has software that posts the invitation to an inbox. When the invitation is posted in the inbox, the recipient is able to view the invitation.

There are several drawbacks to having invitations posted in the inbox. Consider that, the recipient may view the invitation, decide to address it later, and then forget about it. For example, many recipients receive large quantities of messages and invitations daily. Similarly, recipients who have been away from their computer may, upon their return, be inundated by a large amount of messages and invitations. These recipients may fail to see the invitation due to the distraction of all the other messages and invitations.

Attempts have been made to address these problems. For example, software is available to post invitations directly to an electronic calendar. Recipients are able to view all of their invitations in the calendar software. However, viewing the invitations in the calendar requires manually entering the calendar software. The calendar software may have several sections for viewing. The recipients may not be familiar with the operation of the calendar software.

Another attempt to solve these problems includes an autoprocess feature. Autoprocess software can automatically accept or decline all meetings. Users of autoprocess may not be familiar with turning this feature on or off. Autoprocess software provides for automatically accepting invitations from a certain group of people. In these embodiments, invitations from people outside of the group will remain unprocessed.

Typically, invitations that are automatically accepted by autoprocess software will block the recipient's time as required by the invitation. Often, the automatic blocking of time leads to scheduling conflicts with the recipient. Others may want to invite the recipient to a meeting scheduled for the time that was automatically blocked out. Autoprocess software may lead to forcing the recipient to accept a meeting he or she did not want to accept. Further, autoprocess software may accept a meeting while the recipient is out of the office. The recipient may not know about the meeting and fail to attend. The sender will reserve his or her time expecting the recipient to attend.

What are needed are software and hardware for automatically sending reminders to recipients of invitations as disclosed herein.

### SUMMARY OF THE INVENTION

A computer program product including machine readable instructions stored on machine readable media, the product providing a software engine and a calendar, the instructions including instructions for receiving an invitation and automatically generating reminders for invitations that have not been one of accepted and declined.

A system for reminding a user of at least one invitation that has not been one of accepted and declined, the system including a processing system for storing machine readable instructions and interpreting the instructions, and a set of machine readable instructions for operating within the processing system, the instructions including instructions for receiving an invitation and automatically generating at least one reminder for the invitation.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which, provides a computer program add-in product including machine readable instructions stored on machine readable media, the product for automatically generating reminders to recipients of invitations who have not one of accepted and declined an invitation, the instructions including instructions for searching each invitation for a date, a start time, and a time duration; providing reminder generators for each invitation; removing reminder generators for the invitations that are one of accepted and declined by the recipient; displaying each invitation; receiving recipient input to one of accept and decline for each invitation; providing a conflict check between at least two invitations; providing a conflict alert notification to the recipient when at least two invitations conflict; resolving conflicts between at least two invitations; sending an accept message to a sender of an invitation accepted by the recipient; and sending a decline message to a sender of an invitation declined by the recipient.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a computing infrastructure for implementation of the teachings herein;

FIG. 2 depicts aspects of the logic for sending automatic reminders to recipients of invitations;

FIG. 3 depicts aspects of the logic for sending automatic reminders to recipients of invitations when the invitations are accepted;

FIG. 4 depicts aspects of the logic for sending automatic reminders to recipients of invitations when the invitations are accepted and a conflict exists;

FIG. 5 depicts aspects of the logic for resolving conflicts between two invitations; and

FIG. 6 depicts other aspects of the logic for resolving conflicts between two invitations.

The detailed description explains the preferred embodiments of the invention, together with advantages and features, by way of example with reference to the drawings.

### DETAILED DESCRIPTION OF THE INVENTION

The teachings herein describe a computer implemented method and computer hardware to automatically send recipients of invitations reminders if the invitations are not one of accepted and declined.

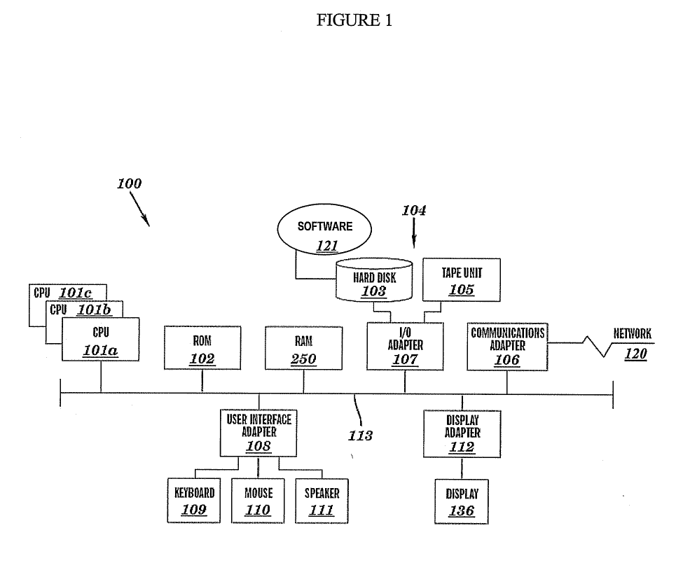

Referring now to FIG. 1, an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 103) for providing automatic reminders to recipients who have not accepted or declined the invitations. As disclosed herein, the instructions are referred to as automatic reminder software 121. The software 121 may be produced using software development tools as are known in the art.

Thus, as configured FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

As is known in the art, the system 100 may perform various functions. For example, the system 100 may provide server capabilities, or provide client resources. The system 100 may operate in a mixed platform environment. For example, the system 100 and other similar resources may operate any one of Windows, AIX and Solaris operating systems. Typically, the software 121 operates in cross platform environments as well as with multiple systems.

A typical embodiment of the network 120 includes a plurality of computer systems 100. Users of the computer systems 100 have the ability to communicate with each other via electronic messages. Typically, the software 121 provides each user with a computer program to manage the electronic messages. The computer program in each of the systems 100 is called a client. The client provides each user with the ability to view, organize, and take actions on the electronic messages. Taking actions on messages may include responding to senders of messages. The user can send an electronic message to any other user connected to the network 120.

The teachings herein discuss invitations. Typically, an invitation is an electronic message that requests the recipient reserves a block of time. Invitations may be sent to one or more recipients. In one example, the invitation is an invitation to a meeting, where a presence of multiple recipients is required.

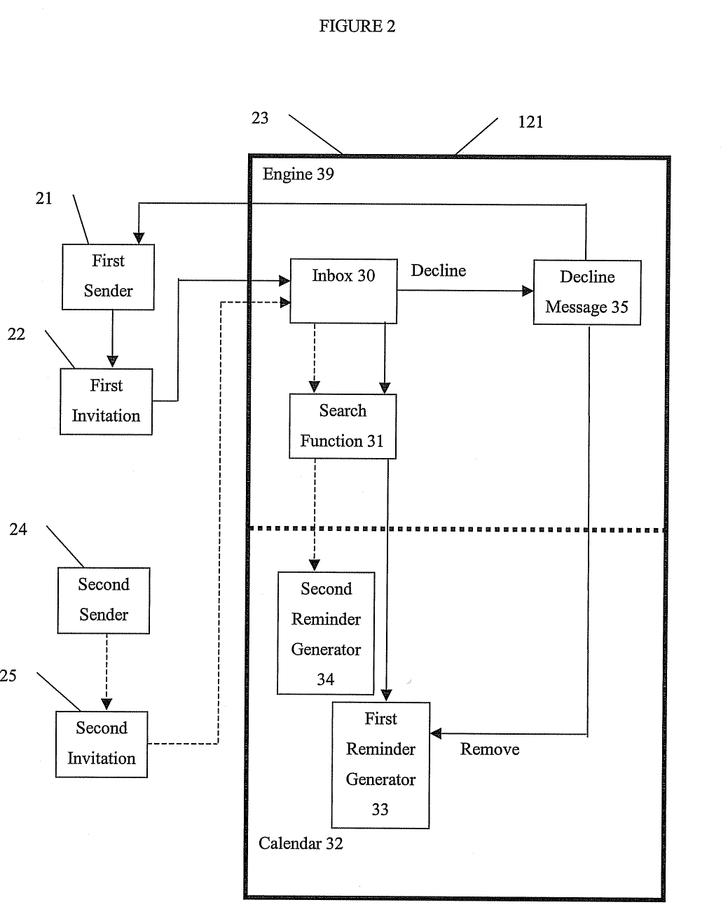

FIG. 2 depicts aspects of the logic for providing automatic reminders. Referring to FIG. 2, a first sender 21 sends an electronic first invitation 22 to a recipient 23 while a second sender 24 sends a second invitation 25 to the recipient 23. The invitations are processed by the software 121. In general, a plurality of senders may make use of systems 100 having software 121 as disclosed herein. Accordingly, a plurality of invitations may be had in various embodiments. For simplicity, the discussion herein refers to the first invitation 23 and the second invitation 25; however, this is merely illustrative and not limiting.

A software engine 39 processes the first invitation 22 for display in an electronic inbox 30. The inbox 30 provides the recipient 23 an ability to view the invitation 22. The inbox 30 also provides the recipient 23 an ability to act on the first invitation 22 by choosing one of accepting and declining. The engine 39 performs a search function 31 on the first invitation 22. The search function 31 searches a subject field, invitation icon, or some other designated portion looking for a meeting date, a start time, and a duration of a meeting. Upon finding the meeting information, the engine 39 will send this information to a calendar 32.

The calendar 32 will create a first reminder generator 33. The first reminder generator 33 will automatically send reminders to the inbox 30. In one embodiment, the sending occurs at a predetermined schedule. The reminders will remind the recipient 23 of the first invitation 22 that has not been one of accepted and declined. Similarly, the second invitation 25 would create a second reminder generator 34. Any reminder generators, once created, will automatically send reminders to the inbox 30. Reminder generators will remain in the calendar 32 until removed. The inbox 30 provides the recipient 23 the ability to resolve any conflicts that may arise between the invitations 22 and 25.

Upon receiving the first invitation 22 in the inbox 30, the recipient 23 can perform one of accepting, declining, and taking no action. If the invitation 22 is declined, the engine 39 sends a decline message 35 to the first sender 21 and the calendar 32.

Upon receiving the decline message 35, the calendar 32 will remove the first reminder generator 33. In one embodiment, the decline message 35 sent to the calendar 32 is an electronic signal. The electronic signal instructs the calendar 32 to remove the first reminder generator 33.

If no action is taken, then the first reminder generator 33 remains in place. The first reminder generator 33 will send reminders to the inbox 30. The reminders will alert the recipient 23 that no action has been taken concerning the first invitation 22.

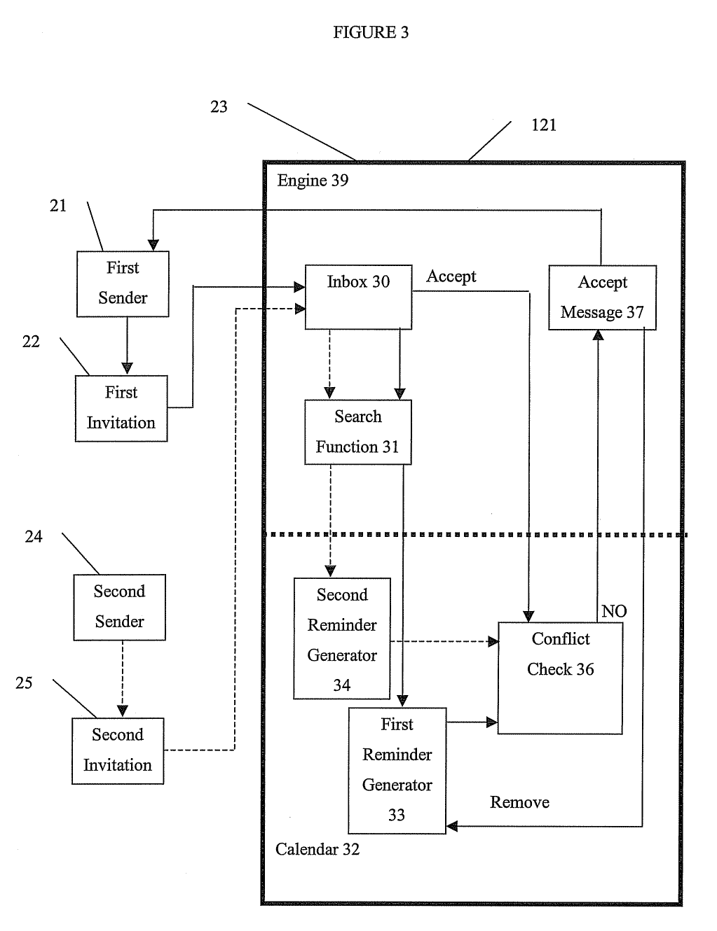

FIG. 3 depicts aspects of the logic for sending automatic reminders when the recipient accepts the first invitation 22. Referring to FIG. 3, if the first invitation 22 is accepted, then a conflict check 36 will be performed by the calendar 32. The conflict check 36 will determine if the second reminder generator 34 accounts for any of the meeting time requested by the first invitation 22. The second reminder generator 34 may represent more than one reminder generator. If the conflict check 36 determines that there is no conflict, then the engine 39 will send an accept message 37 to the sender 21 and the calendar 32. The calendar 32 will reserve the meeting time and remove the first reminder generator 33.

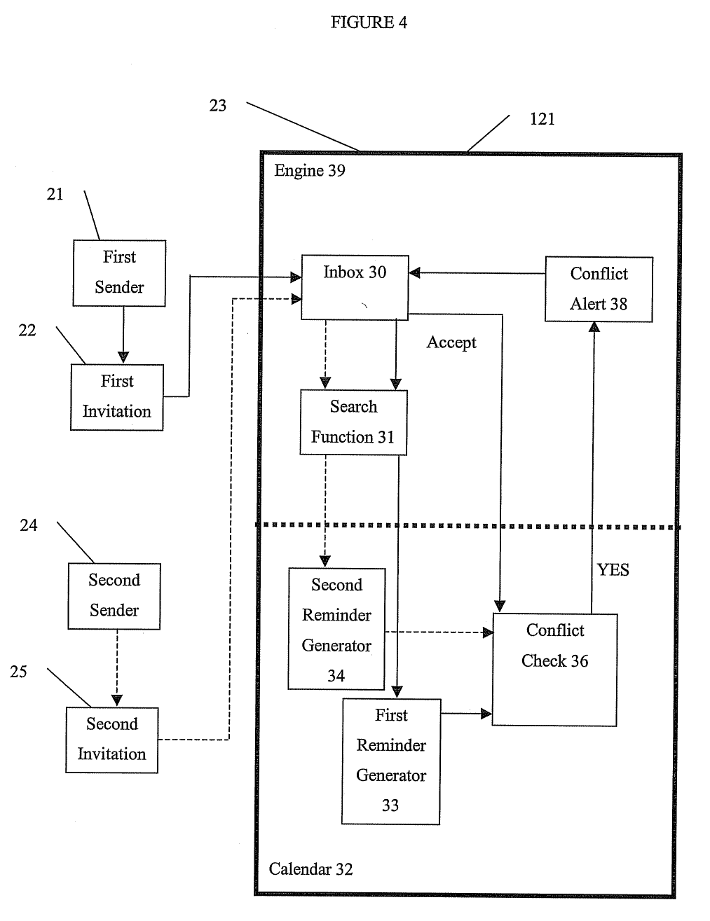

FIG. 4 depicts aspects of the logic for sending automatic reminders with conflicting invitations. Referring to FIG. 4, if the conflict check 36 determines that a conflict exists with the second reminder generator 34, then the calendar 32 will send a conflict alert 38 to the inbox 30. The acceptance will not be processed until the conflict alert 38 is resolved.

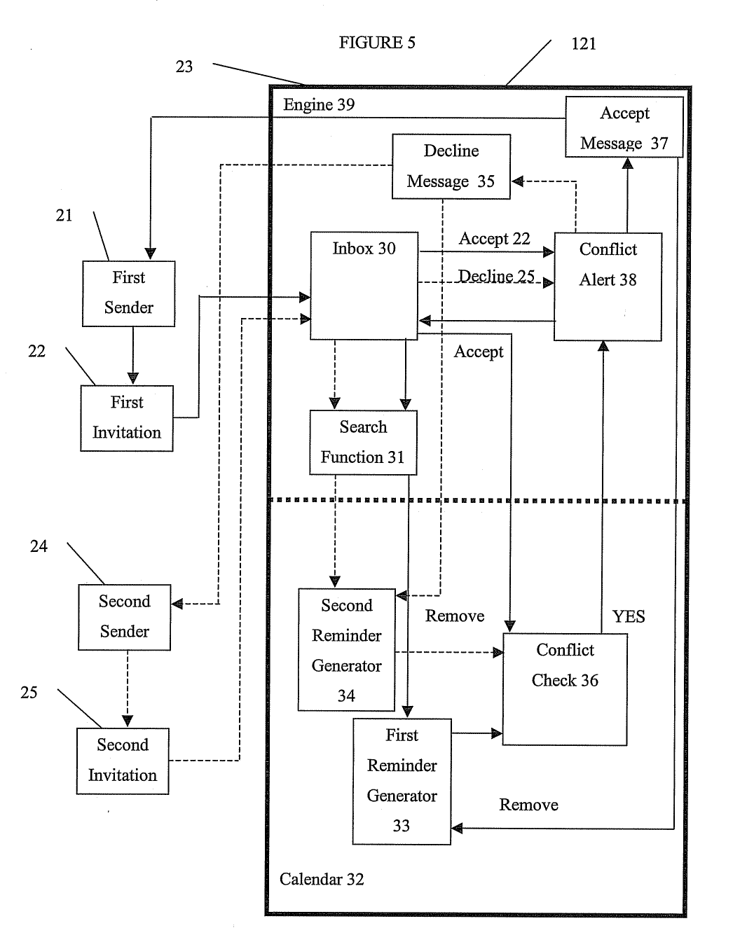

FIG. 5 depicts aspects of the logic for resolving conflicting invitations. Referring to FIG. 5, if the recipient 23 resolves the conflict alert 38 by accepting the first invitation 22, then the engine 39 will send the accept message 37 to the first sender 21 and the calendar 32. The decline message 35 will be sent to the second sender 24 and the calendar 32. The calendar 32 will reserve the meeting time for the first invitation 22. The calendar 32 will remove both the first reminder generator 33 and the second reminder generator 34.

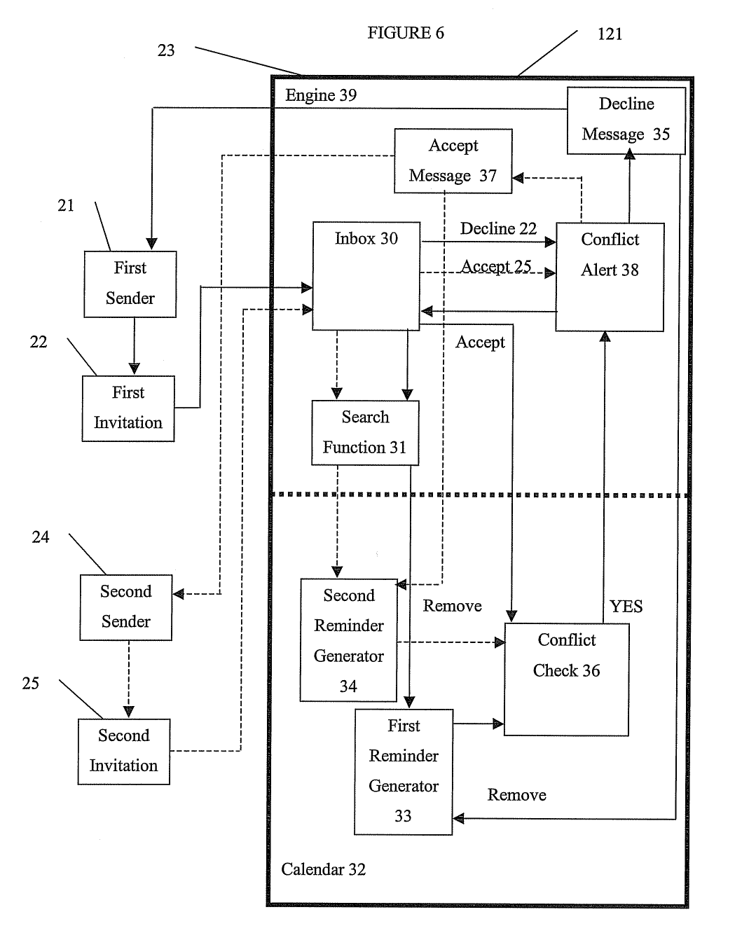

FIG. 6 depicts other aspects of the logic for resolving conflicting invitations. Referring to FIG. 6, if the recipient 23 resolves the conflict alert 38 by accepting the second invitation 25, then the engine 39 will send the accept message 37 to the second sender 24 and the calendar 32. The decline message 35 will be sent to the first sender 21 and the calendar 32. The calendar 32 will reserve the meeting time for the second invitation 25. The calendar 32 will remove both the first reminder generator 33 and the second reminder generator 34.

In some embodiments, the software 121 may be provided as an “add-in” to the client application. For example, the client application may be designed for receiving invitations. The software 121 would supplement the client application to provide automatic reminders for invitations that were not one of accepted and declined by the recipient.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product comprising machine readable instructions stored on machine readable media, the product providing a software engine and a calendar, the instructions comprising instructions for:
receiving an invitation; and
automatically generating reminders for invitations that have not been one of accepted and declined.

2. The computer program product as in claim 1, further comprising instructions for populating an inbox, the populating performed by instructions for:
providing the recipient a display of the invitation;
receiving recipient input to one of accept and decline the invitation; and
resolving conflicts between at least two invitations.

3. The computer program as in claim 1, further comprising instructions to search each invitation for a date, a start time, and a time duration.

4. The computer program product as in claim 1, further comprising instructions for providing a conflict alert notification if two or more invitations conflict with each other.

5. The computer program product as in claim 1, wherein the recipient one of accepts and declines the invitation, and the engine sends a corresponding message to the sender.

6. The computer program product as in claim 1, further comprising instructions for:
creating a reminder generator for each invitation.

7. The computer program product as in claim 1, further comprising instructions for:
removing the reminder generator for each invitation that is one of accepted and declined.

8. The computer program product as in claim 1, further comprising instructions for:
providing a conflict check between at least two invitations.

9. A computer program add-in product comprising machine readable instructions stored on machine readable media, the product for automatically generating reminders to recipients of invitations who have not one of accepted and declined an invitation, the instructions comprising instructions for:
searching each invitation for a date, a start time, and a time duration;
providing reminder generators for each invitation;
removing reminder generators for the invitations that are one of accepted and declined by the recipient;
displaying each invitation;
receiving recipient input to one of accept and decline for each invitation;
providing a conflict check between at least two invitations;
providing a conflict alert notification to the recipient when at least two invitations conflict;
resolving conflicts between at least two invitations;
sending an accept message to a sender of an invitation accepted by the recipient; and
sending a decline message to a sender of an invitation declined by the recipient.

10. A system for reminding a user of at least one invitation that has not been one of accepted and declined, the system comprising:
a processing system for storing machine readable instructions and interpreting the instructions;
and a set of machine readable instructions for operating within the processing system, the instructions comprising instructions for receiving an invitation and automatically generating at least one reminder for the invitation.
